(19) United States
(12) Patent Application Publication
(10) Pub. No.: US 2019/0368624 A1
(43) Pub. Date: Dec. 5, 2019

(54) PRESSURE RELEASE VALVE

(71) Applicant: ROGUE ENERGIES, LLC, Central Point, OR (US)

(72) Inventors: Jacob ENSIGN, Rogue River, OR (US); Travis WHITNEY, Mt. Shasta, CA (US)

(21) Appl. No.: 16/431,070

(22) Filed: Jun. 4, 2019

Related U.S. Application Data
(60) Provisional application No. 62/680,236, filed on Jun. 4, 2018.

(51) Int. Cl. F16K 17/04; F16K 15/18

(52) U.S. Cl. CPC F16K 17/048; F02M 63/023; F16K 15/18

(57) ABSTRACT

A pressure release valve, having three or more cavities is described. The pressure release valve comprises a valve body with at least three valve cavities for fluid. The first valve cavity contains high-pressure fluid and the second cavity contains low-pressure fluid. The first, second, and third cavities are separate and apart from one another. The pressure release valve further includes a movable valve body shaft with a valve hammer and an elastic spring body. The pressure release valve further includes a channel and a valve port, wherein when pressure is applied to the movable valve body shaft, the movable valve body shaft is actuated to press against the valve hammer forcing the valve hammer to move opening the port allowing fluid to flow from the first cavity, to the second cavity and the third cavity.

### CROSS-REFERENCE TO RELATED APPLICATION

The present disclosure claims the benefit of U.S. Provisional Patent Application No. 62/680,236, filed on Jun. 4, 2018, the disclosure of which is incorporated herein in its entirety.

### FIELD OF INVENTION

The present disclosure is directed to a pressure release valve. More particularly, the disclosure is directed to a pressure release valve having three or more cavities.

### BACKGROUND

Pressure release valves used in air riffles, cars, or even hydraulic systems, to name a few, allow pressure to be released from a system. Current valves and pressure release methods can include solenoids, crank shafts, and high tension elastic springs. However, such pressure release valves and methods rely solely on the compression and decompression of the high tension elastic spring or movement of the solenoid or crank shaft to open and close the valves to release pressure. Such valves do not utilize additional forces to assist in opening and closing the valves.

### SUMMARY OF THE INVENTION

In one embodiment, a pressure release valve including a valve body having at least three valve cavities for fluid. A first cavity contains high-pressure fluid and a second cavity contains low-pressure fluid. The first cavity, the second cavity, and a third cavity are separate and apart from one another. The valve body further includes a movable valve body shaft, a valve hammer, and an elastic spring body. The valve body also has a channel and a valve port. When pressure is applied to the movable valve body shaft, the movable valve body shaft is actuated to press against the valve hammer forcing the valve hammer to move opening the valve port allowing fluid to flow from the first cavity, to the second cavity and the third cavity.

In another embodiment, a pressure release valve includes a valve body having at least three fluid cavities, a movable valve body shaft, and a valve hammer. The valve body also has an elastic spring body, a channel, and a valve port. When force is applied to the movable valve body shaft, the movable valve body shaft is actuated, allowing a fluid into one of the at least three cavities and pressing against the valve hammer. The valve hammer moves to open the valve port allowing the fluid to flow from a first cavity of the at least three cavities, to a second cavity of the at least three cavities.

In yet another embodiment, a method for actuating a pressure release valve includes applying a force on a movable body shaft contained inside the pressure release valve and pressing the movable body shaft into a valve hammer. As the movable body shaft moves the valve hammer, an elastic spring body is compressed. The method also includes opening channels and a port between at least three valve cavities, including a first cavity containing high pressure fluid, a second cavity containing low pressure fluid. The first cavity, the second cavity, and a third cavity are separate and apart from one another. When the channels and the port are opened, the high pressure fluid flows between the at least three cavities, filling the third cavity.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates a cross-section of an exemplary pressure release valve in a closed state;

FIG. 2 illustrates a cross-section of the pressure release valve of FIG. 1 in an open state;

FIG. 3 illustrates a cross-section of an alternative pressure release valve in the closed state;

FIG. 4 illustrates a cross-section of the alternative pressure release valve of FIG. 3 in an open state;

FIG. 5 illustrates a cross-section of another alternative pressure release valve in the closed state;

FIG. 6 illustrates a cross-section of the pressure release valve of FIG. 5 in an open state;

FIG. 7 illustrates a cross-section of another alternative pressure release valve in the closed state;

FIG. 8 illustrates a cross-section of the pressure release valve of FIG. 7 in an open state;

FIG. 9 illustrates a flowchart of a method for actuating the pressure release valve.

### DETAILED DESCRIPTION

The disclosure is described in the context of utilizing a multi-chamber pressure release valve. This pressure release valve is described in terms of a flow of fluids, including both gasses and liquids. Therefore, the valve may be either a pneumatic valve or a hydraulic valve.

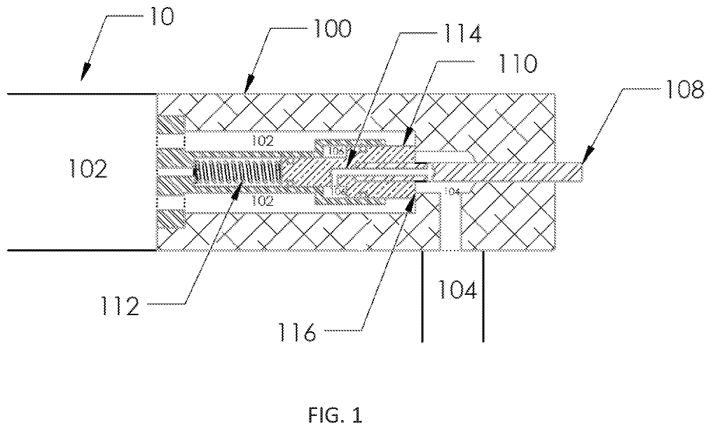

FIG. 1 illustrates a cross-section of the pressure release valve in a closed state before acted on by any outside forces. The pressure release valve 10 includes a valve body 100, three cavities, a first cavity 102, a second cavity 104, and a third cavity 106, a movable body shaft 108, a valve hammer, 110, and an elastic spring body 112. In another embodiment, more than three cavities can be utilized in the pressure release valve 10, with each of the cavities remaining separate and distinct from one another and not allowing fluid to flow through the channels 114. FIG. 1 has a pressure balance passageway running through the stem of the valve into cavity 106.

The movable body shaft 108 includes internal channels 114. The pressure release valve 10 also includes port 116 shown here in a closed state. The port 116 allows fluid to flow freely between the first cavity 102, second cavity 104, and third cavity 106 when opened. In a non-activated state, the elastic spring body 112 is uncompressed and provides a biasing force on the valve hammer 110 to keep it from moving and exposing the first cavity 102, second cavity 104, and third cavity 106. The elastic spring body 112 is shown as a coil spring, however, in other embodiments, the elastic spring body 112 may be an elastomeric member or magnetic means.

In one embodiment, the pressure release valve 10 is secured to an air rifle, pneumatic air gun, hydraulic system or the like using an attachment mechanism (not shown in the drawings), such as a screw thread.

The pressure release valve 10 facilitates the flow of fluid through the valve from a point of high pressure to a point of lower pressure when an outside force activates the valve. The first cavity 102, second cavity 104, and third cavity 106, are distinct and separate from one another, blocked by a valve hammer 110. The first cavity 102 is a high-pressure cavity, such as a cartridge of compressed air or gas, such as nitrogen. In alternative embodiments, the valve could utilize, but is not limited to, oxygen, argon, carbon dioxide, helium, propane, or butane. In another embodiment, the pressure release valve could facilitate the flow of liquid, such as, but not limited to, water, acetone, fuel, or bleach.

Each of the three cavities, first cavity 102, second cavity 104, third cavity 106 have channels that allow the pressure to flow from a cavity of high pressure 102 to a cavity of lower pressure second cavity 104, third cavity 106 when the port 116 is opened. As shown in FIG. 1, second cavity 104 opens to the atmosphere. In another embodiment, second cavity 104 may be a sealed cavity contained within the pressure release valve. Cavity 104 may be any alternate volume with a pressure lower than volume 102, and sealed from each other via the valve assembly.

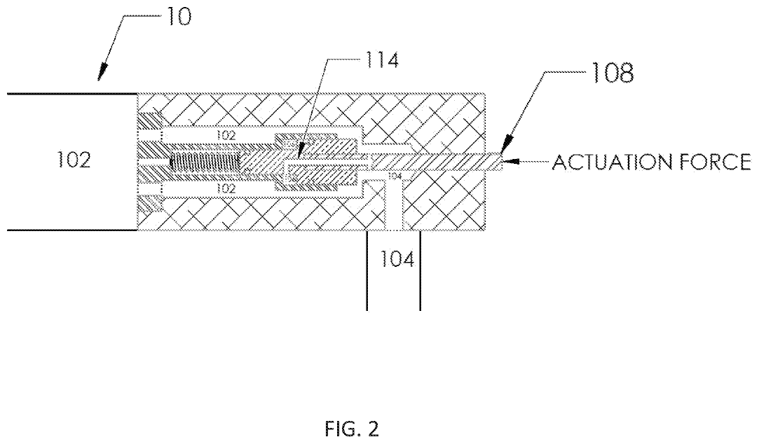

FIG. 2 illustrates a cross-section of the pressure release valve of FIG. 1 in an open state. In an activated state, an external force has activated the movable body shaft 108. As the movable body shaft 108 moves the valve hammer 110, the elastic spring body 112 is compressed and the port between the first cavity 102 and second cavity 104 is opened. This allows pressurized fluid to pass through the channels 114 from a high-pressure cavity, first cavity 102 to a lower pressure cavity, second cavity 104.

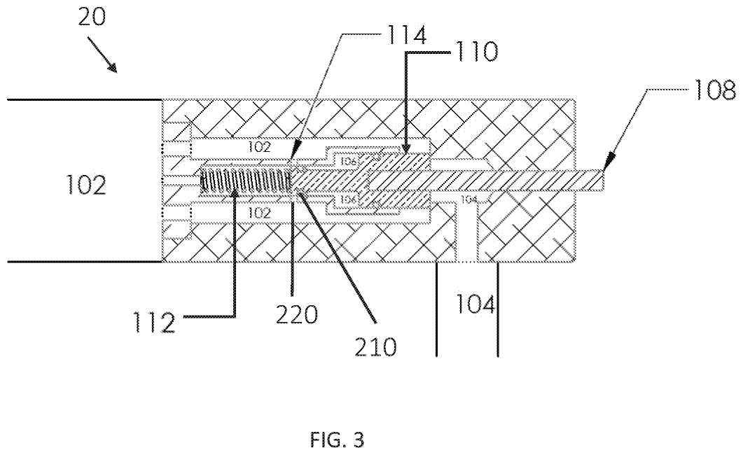

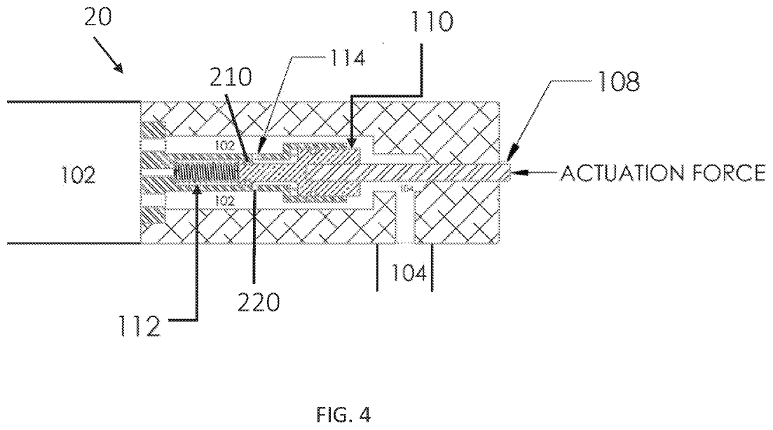

FIGS. 3 and 4, illustrate cross-sections of an alternative pressure release valve 20 in a closed and open state, respectively. Pressure Release valve 20 is substantially the same as pressure release valve 10 except for the differences detailed herein. Like reference numerals are used for like elements. As shown in FIG. 3, pressure cannot flow through the valve from the high-pressure first cavity 102 to lower pressure second cavity 104 and third cavity 106 as the channels 114 connecting the cavities are blocked. The movable body shaft 108 rests in a relaxed state and does not produce an actuating force on the valve hammer 110. Further, as a result of this untouched and relaxed state, the elastic spring body 112 also remains in a non-compressed state, biasing the valve hammer to a closed position. FIG. 3 has a pressure balance passageway in the wall of the thimble, so when the valve is opened, the sealing O-ring 210 passes by small apertures 220, and allows high-pressure air into cavity 106.

FIG. 4 illustrates the pressure release valve 10 when an external force has acted on the movable body shaft 108, thereby opening the channels 114 between the first cavity 102, and third cavity 106. The valve can be actuated by any force on the movable body shaft 108. In one embodiment, an external force may include pulling a trigger of an air rifle. In an alternative embodiment, the external force may include force from a pneumatic actuator. In an alternative embodiment, the external force may include force from an electronic solenoid.

As the valve hammer 110 continues to move from the force of the movable body shaft 108 toward the elastic spring body 112, the channel 114 directly connecting third cavity 106 and first cavity 102 is opened thus putting all three cavities first cavity 102, second cavity 104, and third cavity 106 in direct communication with one another. As the high-pressure fluid flows from first cavity 102 into third cavity 106, the force of the high-pressure fluid fills the third cavity 106 and exerts a closing force on the valve hammer 110. Additionally, as the pressure of the third cavity 106 builds, and the tension from the elastic spring body acts on the valve hammer 110, the valve hammer 110 is pushed back into a closed position sealing the channel 114 and port 116 between the first cavity 102, second cavity 104, and third cavity 106, and the pressure release valve returns to a closed state (as shown in FIGS. 1 and 3). The movements of the pressure release valve 10 occur in fractions of seconds. Third cavity 106 is pivotal in closing and securing the channels 114 and port 116. While the elastic spring body 112 assists in forcing the movable body shaft 108 back to a closed and relaxed state, the tension required on the elastic spring body would need to be high. The different diameters of the valve hammer create the third cavity 106. The elastic spring body requirement is infinitely variable depending upon the system requirements. Third cavity 106 aids the elastic spring body 112 by applying force on the valve hammer 110 as the third cavity 106 fills with high-pressure fluid from first cavity 102.

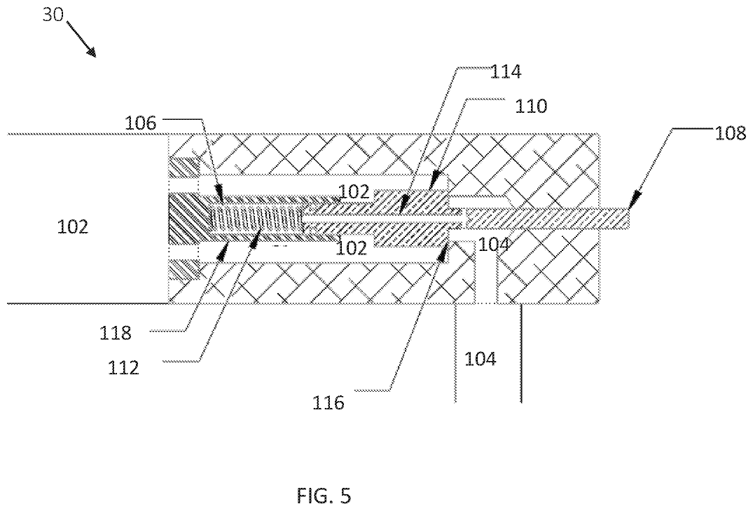

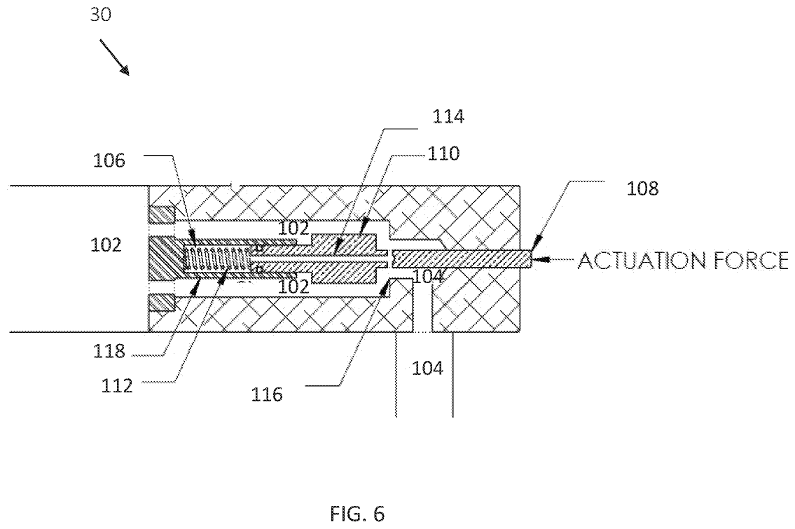

FIGS. 5 and 6, illustrate cross-sections of yet another alternative pressure release valve 30 in a closed and open state, respectively. Pressure Release valve 30 is substantially the same as pressure release valve 10 and 20 except for the differences detailed herein. Like reference numerals are used for like elements. As shown in FIG. 5, fluid cannot flow through the valve from the high-pressure first cavity 102 to lower pressure second cavity 104 as the valve hammer 110 is blocking the fluid flow through the cavities. The movable body shaft 108 rests in a relaxed state and does not produce an actuating force on the valve hammer 110 and prevents the flow of air into the lower pressure third cavity 106 through the channels 114. Further, as a result of this untouched and relaxed state, the lower pressure third cavity 106 and the elastic spring body 112 also remains in a non-compressed state, in the third cavity enclosure 118 biasing the valve hammer to a closed position.

FIG. 6 illustrates the pressure release valve 30 when an external force has acted on the movable body shaft 108, thereby forcing air into the channel 114 and into the third cavity 106. The valve can be actuated by any force on the movable body shaft 108. In one embodiment, an external force may include pulling a trigger of an air rifle. In an alternative embodiment, the external force may include force from a pneumatic actuator. In an alternative embodiment, the external force may include force from an electronic solenoid.

As the valve hammer 110 continues to move from the force of the movable body shaft 108 toward the elastic spring body 112, the first cavity 102 and second cavity 104 is opened thus putting the in direct communication with one another. As the high-pressure fluid flows from first cavity 102 into second cavity 104, the force of the high-pressure fluid fills the second cavity 104 and exerts a closing force on the valve hammer 110. Additionally, as the pressure of the third cavity 106 builds, and the tension from the elastic spring body acts on the valve hammer 110, the valve hammer 110 is pushed back into a closed position and port the first cavity 102, the second cavity 104, and the pressure release valve returns to a closed state (as shown in FIG. 5). The movements of the pressure release valve 10 occur in fractions of seconds. Third cavity 106 is pivotal in closing and securing the port 116. While the elastic spring body 112 assists in forcing the movable body shaft 108 back to a closed and relaxed state, the tension required on the elastic spring body would need to be high. The different diameters of the valve hammer create the third cavity 106. The elastic spring body requirement is infinitely variable depending upon the system requirements. Third cavity 106 aids the elastic spring body 112 by applying force on the valve hammer 110 as the third cavity 106 fills with high-pressure fluid from the force of the movable body shaft 108.

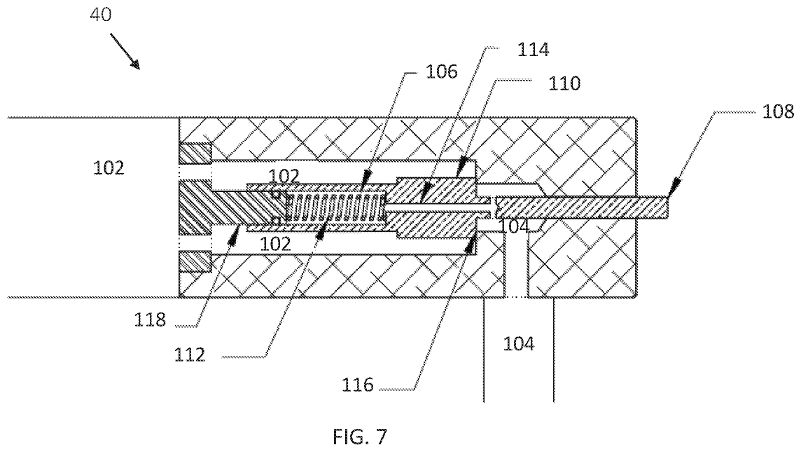

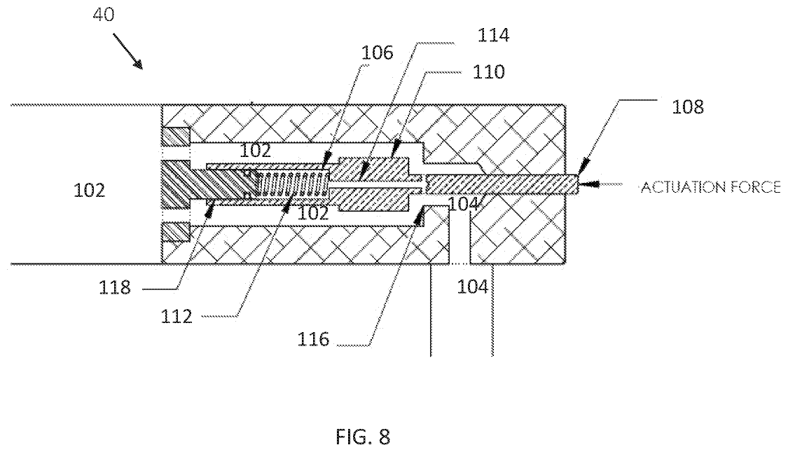

FIGS. 7 and 8, illustrate cross-sections of yet another alternative pressure release valve 40 in a closed and open state, respectively. Pressure release valve 40 is substantially the same as pressure release valve 10, 20 and 30 except for the differences detailed herein. Like reference numerals are used for like elements. As shown in FIG. 7, fluid cannot flow through the valve from the high-pressure first cavity 102 to lower pressure second cavity. The movable body shaft 108 rests in a relaxed state and does not produce an actuating force on the valve hammer 110 state and prevents the flow of air into the lower pressure third cavity 106 through the channel 114. Further, as a result of this untouched and relaxed state, the lower pressure third cavity 106 and the elastic spring body 112 also remains in a non-compressed state, biasing the valve hammer to a closed position.

FIG. 8 illustrates the pressure release valve 40 when an external force has acted on the movable body shaft 108, thereby forcing high pressure through the channel 114 and into the third cavity 106. The valve 40 can be actuated by any force on the movable body shaft 108. In one embodiment, an external force may include pulling a trigger of an air rifle. In an alternative embodiment, the external force may include force from a pneumatic actuator. In another alternative embodiment, the external force may include force from an electronic solenoid.

As the valve hammer 110 continues to move from the force of the movable body shaft 108 toward the elastic spring body 112, the port 116 opens putting the first cavity 102 and second cavity 104 in direct communication with one another. Additionally, as movable body shaft 108 forces pressure from the channel 114 into the third cavity 106 and moves the valve hammer 110 into the elastic spring body 112 forcing the elastic spring body 112 to compress. As the pressure builds in the third cavity 106, and the tension from the elastic spring body 112 acts on the valve hammer 110, the valve hammer 110 is pushed back into a closed position sealing the port 116 between the first cavity 102 and the second cavity 104, and the pressure release valve returns to a closed state (as shown in FIG. 7). The movements of the pressure release valve 40 occur in fractions of seconds. Third cavity 106 is pivotal in closing and securing the port 116. While the elastic spring body 112 assists in forcing the movable body shaft 108 back to a closed and relaxed state, the tension required on the elastic spring body would need to be high. The different diameters of the valve hammer create the third cavity 106. The elastic spring body requirement is infinitely variable depending upon the system requirements. Third cavity 106 aids the elastic spring body 112 by applying force on the valve hammer 110 as the third cavity 106 fills with high-pressure fluid from first cavity 102.

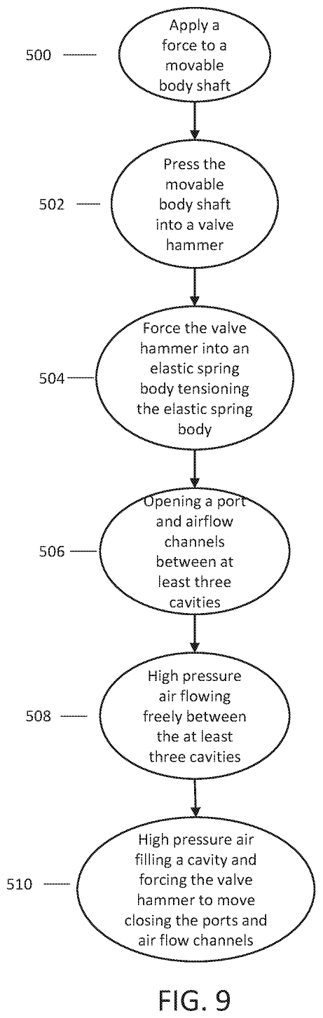

The flowchart of FIG. 9, illustrates an exemplary method for activating the pressure release valve 10. When the pressure release valve 10 is activated, the movable body shaft 108 moves activating the valve hammer 110 allowing the pressure to flow through the channels 114 and opening port 116 eliminating the need for a high tensioned elastic spring body 112. At rest, the at least three cavities of the pressure release valve are not in connection with one another. At 500, an external force is applied to a movable body shaft. This force pushes the moveable body shaft into the valve hammer 502, which in turn compresses the elastic spring body 504. As the valve hammer moves and the elastic spring body is compressed, the port and channels between the at least three cavities is opened 506. When the ports and channels are opened, high-pressurized fluid from one channel rushes through the ports and channels 508 both filling the third cavity 106 and exiting the pressure release valve through the second cavity 104. As the high pressure fluid fills the third cavity and the elastic spring body and the force of the high pressure fluid in the third cavity exert a force on the valve hammer forcing it to move back in the opposite direction 510. When the valve hammer reaches its resting state, the port and channels between the at least three cavities is closed and high pressure fluid no longer flows freely through the valve. The overall open and close of the pressure release valve is completed in fractions of a second.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

The above merely illustrates the principles of the invention. It is thus appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A pressure release valve, comprising:
a valve body including:
at least three valve cavities for fluid, wherein a first cavity contains high-pressure fluid, a second cavity contains low-pressure fluid, and the first cavity, the second cavity, and a third cavity are separate and apart from one another;
a movable valve body shaft;
a valve hammer;
an elastic spring body;
a channel; and
a valve port;
wherein when pressure is applied to the movable valve body shaft, the movable valve body shaft is actuated to press against the valve hammer forcing the valve hammer to move opening the valve port allowing fluid to flow from the first cavity, to the second cavity and the third cavity.

2. The pressure release valve of claim 1, wherein when the high-pressure fluid flows from the first cavity, to the third cavity, the high pressure fluid fills the third cavity, and pressure from the third cavity and the elastic spring body force the valve hammer rapidly closed sealing the first cavity, the second cavity, and the third cavity apart from one another.

3. The pressure release valve of claim 1, wherein the high-pressure fluid of the first cavity is a high pressure air or gas including at least one of nitrogen, oxygen, argon, carbon dioxide, helium, propane, or butane.

4. The pressure release valve of claim 1, wherein the high-pressure fluid of the first cavity is a high pressure liquid including one of water, acetone, fuel, or bleach.

5. The pressure release valve of claim 1, wherein the elastic spring body has a tension.

6. The pressure release valve of claim 1, wherein the first cavity, the second cavity, and the third cavity are opened and closed in milliseconds.

7. The pressure release valve of claim 1, wherein the elastic spring body maintains a constant force on the valve hammer.

8. The pressure release valve of claim 1, wherein when the elastic spring body is one of a coil spring, elastomeric member or magnet.

9. The pressure release valve of claim 1, wherein the valve body is used in one of at least gas pressure systems and hydraulic fluid systems.

10. A pressure release valve, comprising:
a valve body including:
at least three fluid cavities;
a movable valve body shaft;
a valve hammer;
an elastic spring body;
a channel; and
a valve port,
wherein when force is applied to the movable valve body shaft, the movable valve body shaft is actuated, allowing a fluid into one of the at least three cavities and pressing against the valve hammer, the valve hammer moving to open the valve port allowing the fluid to flow from a first cavity of the at least three cavities, to a second cavity of the at least three cavities.

11. The pressure release valve of claim 10 wherein, the first cavity contains high-pressure fluid and the second cavity contains low-pressure fluid, and the first cavity, the second cavity, and a third cavity are separate and apart from one another.

12. The pressure release valve of claim 11 wherein, the elastic spring body is located within the third cavity.

13. The pressure release valve of claim 11, wherein when the movable valve body shaft is actuated, it moves into the valve hammer, forcing the valve hammer to compress the elastic spring body in the third cavity, and allowing fluid into the third cavity.

14. The pressure release valve of claim 11, wherein when the high-pressure fluid flows from the first cavity, to the second cavity the high-pressure fluid fills the second cavity, and fluid from the third cavity and the elastic spring body force the valve hammer closed, sealing the first cavity, the second cavity, and the third cavity apart from one another.

15. The pressure release valve of claim 11, wherein the first cavity, the second cavity, and the third cavity are opened and closed in milliseconds and the elastic spring maintains a constant force on the valve hammer.

16. The pressure release valve of claim 10, wherein the elastic spring body has a tension.

17. A method for actuating a pressure release valve, the method comprising:
applying a force on a movable body shaft contained inside the pressure release valve;
pressing the movable body shaft into a valve hammer, wherein as the movable body shaft moves the valve hammer, an elastic spring body is compressed;
opening channels and a port between at least three valve cavities, a first cavity containing high pressure fluid, a second cavity containing low pressure fluid, and the first cavity, the second cavity, and a third cavity being separate and apart from one another, wherein when the channels and the port are opened, the high pressure fluid flows between the at least three cavities, filling the third cavity.

18. The method for actuating a pressure release valve of claim 17, further comprising closing the pressure release valve when force from the compressed and tensioned elastic spring body and the third cavity forces the valve hammer closed sealing the channels and the port.

19. The method for actuating a pressure release valve of claim 17, wherein the first cavity, the second cavity, and the third cavity are opened and closed in milliseconds.

20. The method for actuating a pressure release valve of claim 17, wherein the elastic spring body maintains a constant force on the valve hammer.
